(19) United States
(12) Patent Application Publication
(10) Pub. No.: US 2016/0371977 A1
(43) Pub. Date: Dec. 22, 2016

(54) APPARATUS, SYSTEMS, AND METHODS FOR PROVIDING INTELLIGENT VEHICULAR SYSTEMS AND SERVICES

(71) Applicant: ANALOG DEVICES, INC., Norwood, MA (US)

(72) Inventors: DAVID WINGATE, PROVO, UT (US); HARVEY WEINBERG, SHARON, MA (US); BENJAMIN VIGODA, WINCHESTER, MA (US)

(73) Assignee: ANALOG DEVICES, INC., Norwood (US)

(21) Appl. No.: 15/121,435

(22) PCT Filed: Feb. 26, 2015
(86) PCT No.: PCT/US2015/017828

§ 371 Date: Aug. 25, 2016

Related U.S. Application Data
(60) Provisional application No. 61/944,889, filed on Feb. 26, 2014.

(51) Int. Cl. G08G 1/0968; G07C 5/00; G10L 15/22; B60W 50/10; G01C 21/34; H04R 3/04; G08G 1/01; B60W 50/16

(52) U.S. Cl. CPC G08G 1/096866; G08G 1/0112; G08G 1/096844; G07C 5/008; B60W 50/16; B60W 50/10; G01C 21/3492; H04R 3/04; G10L 15/22; B60W 2540/02; B60W 2420/54; B60W 2750/40; B60W 2420/52; H04R 2499/13

(57) ABSTRACT

A system is provided for updated processing of audio signals in a vehicle. The system includes a microphone, a transceiver and head unit. The microphone receives audio signals. The transceiver sends the received audio signals to a cloud computing system for processing, and receives the processed audio signals from the cloud computing system. The head unit receives the processed audio signals from the transceiver and plays the processed audio data through the vehicle's audio system.

### CROSS-REFERENCE TO RELATED APPLICATION

This Application claims priority to U.S. Patent Application Ser. No. 61/944,889, filed Feb. 26, 2014, which Application is considered incorporated by reference into the disclosure of this Application.

### TECHNICAL FIELD

Disclosed apparatus, systems, and methods relate to providing intelligent vehicular systems and services.

### BACKGROUND

There are many vehicular systems that can be improved. For example, vehicle users frequently use maps and mapping applications to determine one or more routes to a destination. Many mapping applications provide updated traffic information based on traffic reports. However, any additional information about a route is not available until a user is on the road and can make first hand observations.

Additionally, information about car accidents and the causes of car accidents frequently remains unknown or confidential, and is often not available to improve car safety systems.

Another example is vehicle sound systems, which are usually controlled by a head unit that is designed and installed by the manufacturer. However, vehicles are frequently used for 10-15 years after manufacture, and the head units are not easily updated. Replacing a head unit is very expensive. Thus, many cars have outdated systems.

Last, vehicles often have many systems for a user to control, resulting in a busy and crowded user interface with many knobs and buttons. Additional systems are not easily added since there is no space for another interface.

### SUMMARY

The present disclosure includes apparatus, systems, and methods for providing intelligent vehicular systems and services. Some embodiments of an intelligent vehicular system include a vehicle having an actuation system, a sensor system, a control system, and an infotainment system. The actuation system provides mechanisms for mechanically actuating subsystems of a vehicle, such as a steering wheel, an accelerator, a brake, and a suspension system. The sensor system provides mechanisms for sensing various information about the vehicle and its surroundings. For example, the sensor system includes an image sensor (e.g., a camera), a sonar sensor, a LIDAR sensor, and/or a RADAR sensor for sensing the surroundings of the vehicle. As another example, the sensor system can also include sensors for detecting the operational status (e.g., health) of the actuation system, or any information relating to the operation of the vehicle. The control system provides mechanisms for controlling the sensor system and/or the actuation system. The control system can operate in conjunction with a processor and a memory device residing in the vehicle. The infotainment system can provide information and entertainment to passengers and/or drivers in a vehicle.

Some embodiments of an intelligent vehicular system also include a cloud computing (CC) system. The CC system can communicate with the above-described vehicle to provide intelligent services to the vehicle driver and/or passengers based on the status of the vehicle sensed by the vehicle's sensor system. The CC system in the intelligent vehicular system is particular useful when the amount of sensor data gathered by the above-described vehicle is too large to be analyzed locally at the vehicle. The CC system is also useful when the service provided to the vehicle driver and/or passengers can be enhanced by sensor data gathered by other vehicles.

According to one aspect, a system is provided for updated processing of audio signals in a vehicle. The system includes a microphone, a transceiver and head unit. The microphone is for receiving audio signals. The transceiver sends the received audio signals to a cloud computing system for processing, and receives the processed audio signals from the cloud computing system. The head unit receives the processed audio signals from the transceiver and plays the processed audio data through the vehicle's audio system.

According to one implementation, the cloud computing system processing of the received audio signals includes source separation processing. In another implementation, the transceiver is a cell phone transceiver, and the cell phone is wirelessly connected to the vehicle. In one example, the cellphone is wirelessly connected to the vehicle using a Bluetooth connection.

According to another aspect, a system for updating the function of a tactile interface in a vehicle comprises a voice recognition system, a tactile interface, and a processor. The voice recognition system is for identifying a voice command. The tactile interface is for receiving a tactile input. The processor is for connecting a user system in the vehicle with the tactile interface based on the identified voice command, and for processing the tactile input to update the connected user system.

According to one implementation, the tactile interface includes one of capacitve sensors and optic sensors for identifying a user grip. In one example, the user grip includes at least one of a left-handed grip, a right-handed grip, a two-fingered grip, a three-fingered grip, a four-fingered grip, and a five-fingered grip. In one implementation, the tactile interface is one of a knob, a switch, and a button.

According to one aspect, a method of enhancing map data is provided, comprising accessing current map data, collecting data from sensors in multiple vehicles, determining road conditions based on the collected sensor data, and enhancing the current map data to include the road conditions. The sensors include at least one of LIDAR sensors, radar sensors and inertial sensors. In one example, the sensor data is sent from multiple different vehicles to a cloud (crowd-sourced), and can be used to update maps with various route-related information such as road conditions.

According to one implementation, determining road conditions includes identifying changes in the road surface. Changes in the road surface may include at least one of potholes, ice, water, puddles, gravel, sand, and debris. In another implementation, determining road conditions includes identifying road closures, lane closures, and detours. According to on implementation, collecting data from sensors in multiple vehicles includes receiving sensor data, wherein the sensor data is received from one of a vehicle radio unit and a phone connected to a vehicle head unit.

In one implementation, sensor data from multiple cars is uploaded to a cloud and used to determine road maintenance requirements. For example, bridge health can be monitored based on car sensor data, wherein the car sensor data may measure bridge vibrations and bridge movements.

According to one aspect, a system for improving vehicle safety by analyzing data from vehicle accidents comprises a plurality of sensors installed in a vehicle for sensing vehicle information, a circular buffer for recording the vehicle information, and a transmitter for transmitting data from the circular buffer to a cloud computing resource. The circular buffer is continuously refreshed, and any vehicle information in the circular buffer at the time of a vehicle accident is saved. According to one implementation, the plurality of sensors include at least one of a LIDAR sensor, a radar sensor, an inertial sensor, an accelerometer, and a camera. According to another implementation, identifying information is removed from the vehicle information. Identifying information includes information that can be used to identify the vehicle involved in the accident.

According to another aspect, a system for personalizing vehicle sounds comprises a selection module including a plurality of personalized vehicle sounds for user selection, wherein vehicle sounds include engine sounds, indicator sounds, and warning sounds, and a head unit for receiving the personalized vehicle sound selections from the selection module and playing the personalized vehicle sounds through a vehicle's audio system.

In some embodiments, the CC system can cooperate with the sensor system and/or the control system in the vehicle to extend the capability of the sensor system without the need for expensive sensors. Such enhancements of a sensor system can be computationally expensive. Therefore, the vehicle can offload such extensive computations to the CC system having a more powerful computation platform. The CC system can cooperate with the sensor system and/or the control system to estimate the status of one or more subsystems that is hard to measure using a conventional sensor system. For example, the CC system can estimate the center of gravity of the vehicle in real time based on the sensor measurements of the tire pressures and the location of the passengers in the vehicle cabin. As another example, the CC system can cooperate with the sensor system and/or the control system to improve the accuracy of the conventional sensor system.

In some embodiments, the CC system can cooperate with the sensor system and/or the control system to gather real-time information about the vehicle. This allows the CC system to monitor the operational status of the vehicle over a period of time, and, if needed, provide an intervention to prevent undesirable events or to generate new business opportunities. For example, when the CC system detects that a subsystem of a vehicle, such as a suspension system, is about to fail, the CC system can send a warning signal to the driver to indicate that the suspension system requires a repair. Also, when a subsystem of a vehicle is about to fail, the CC system can send a targeted advertisement to the driver for the about-to-fail subsystem. In some embodiments, the analysis of the data from the sensor system can be performed locally at the control system of the vehicle.

Some embodiments of an intelligent vehicular system can provide an enhanced driver experience. For example, the vehicle can adapt to the characteristics of the driver. As another example, the vehicle can be equipped with a tactile interface, also referred to as a haptic interface, a tactile knob, a haptic knob, or an “Awesome knob,” that provides a fluidic mechanism for controlling features of the vehicle. As another example, the vehicle can include an automatic acoustic noise cancellation system to reduce the noise level in the vehicle cabin. As another example, the vehicle can use the sound system to direct sound signals to specific locations in the vehicle cabin.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings.

FIG. 1 illustrates an architecture of the disclosed intelligent vehicular system in accordance with some embodiments.

FIG. 2 illustrates a power-line communication system in accordance with some embodiments.

FIG. 3 illustrates a sensor testing platform in accordance with some embodiments.

FIG. 4 illustrates a method for monitoring a vehicle battery in accordance with some embodiments.

FIG. 5 illustrates a headlight status sensor in accordance with some embodiments.

FIG. 6 illustrates a headlight status sensor in conjunction with a light projector in accordance with some embodiments.

FIG. 7 illustrates an intelligent control system in accordance with some embodiments.

FIG. 8 illustrates a communication flow between a control signal generator and a vehicle simulation module in the control system in accordance with some embodiments.

FIG. 9 illustrates a cloud-based voice processing flow in accordance with some embodiments.

FIG. 10 illustrates a computerized method for the operation of an Awesome knob system in accordance with some embodiments.

### DETAILED DESCRIPTION

In the following description, numerous specific details are set forth regarding the apparatus, systems, and methods of the disclosed subject matter and the environment in which such apparatus, systems, and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

The present disclosure relates to apparatus, systems, and methods for providing intelligent vehicular systems and services, including systems and methods of using car sensor data. In one implementation, car sensor data is used for enhanced mapping. In another implementation, car sensor data is used for improving car safety. In one implementation, systems and methods are provided for personalizing car sounds. In a further implementation, a multifunctional knob is provided for enhancing car functionality.

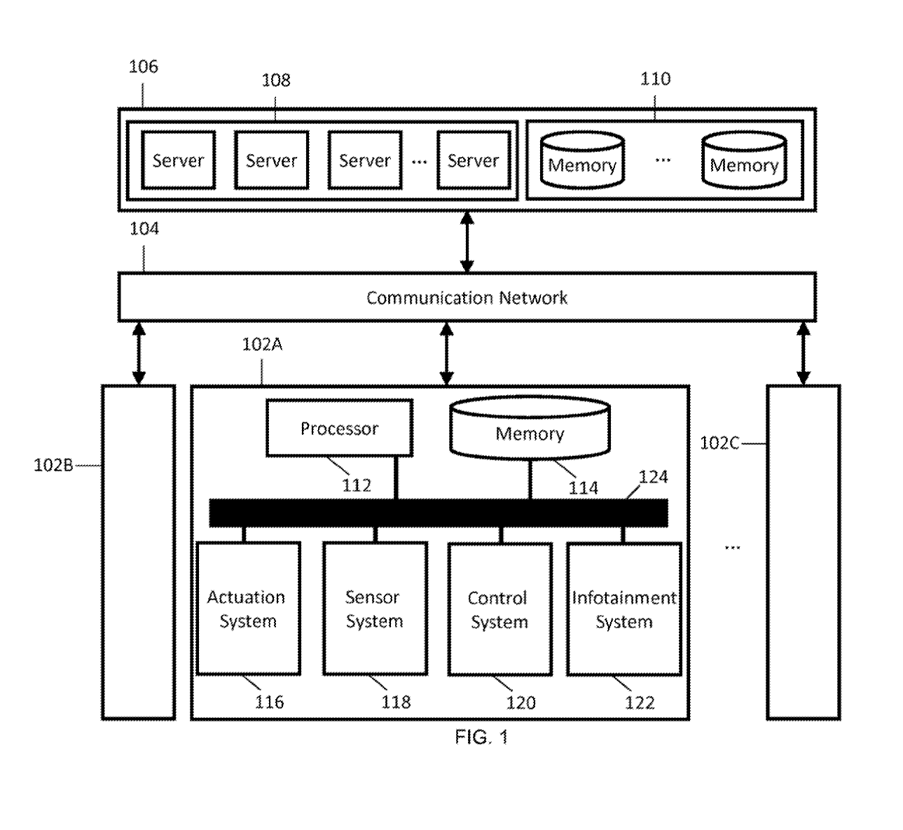

FIG. 1 illustrates the disclosed intelligent vehicular system in accordance with some embodiments. The intelligent vehicular system can include one or more vehicles 102a-102c (referred to herein as a “vehicle 102”), a communication network 104, and a cloud computing system 106 having one or more servers 108 and one or more network storage devices 110.

The vehicle 102 can be capable of transporting passengers or cargo. For example, the vehicle 102 can include a car, a truck, a bus, a cart, and/or a motorcycle. As shown for vehicle 102a, the vehicles 102a-102c can include a processor 112, a memory device 114, an actuation system 116, a sensor system 118, a control system 120, and an information/entertainment system 122, also referred to as an infotainment system.

The actuation system 116 can include one or more actuator devices that are configured to cause a physical movement in the vehicle 102, on the vehicle 102, or around the vehicle 102. For example, the actuation system 116 can include one or more of an engine, a brake system, a wheel steering system, a suspension system that can raise or lower the center of gravity of a vehicle, and a pre-tension seatbelt system.

The sensor system 118 can include one or more sensors that are configured to detect information about the vehicle 102. For example, the sensor system 118 can include an accelerometer for detecting acceleration or deceleration of a vehicle, a temperature sensor, an image sensor, a RADAR sensor, a LIDAR sensor, a sonic sensor, a radio-frequency sensor, an inertial sensor, a gyroscope sensor, a speedometer, an odometer, or any other sensors that are capable of detecting information in or around the vehicle 102. In some cases, the sensor system 118 can include an analog-to-digital converter that is able to convert analog signals generated by one or more sensors into digital signals.

The control system 120 can be configured to receive signals from the sensor system 118 and respond to the received signals using the actuation system 116. For example, if the control system 120 receives a signal from the sensor system 118, indicating that the vehicle 102A is too close to another vehicle, for example, 102B, the control system 120 can be configured to cause the actuation system 116 to reduce or increase the speed of the vehicle 102A to avoid collision.

The infotainment system 122 can include an acoustic system for providing audio signals to passengers. The infotainment system 122 can also include a video system for providing a visual interface to passengers. The video system can include a display that is capable of providing video signals to passengers. The video system can also be coupled to a navigation system for providing map information to a driver. The infotainment system 122 may also include a user interface that allows passengers to interact with the acoustic system and the video system. The user interface can include a tactile interface (e.g., a haptic interface) that allows passengers to physically interact with the infotainment system 122.

Two or more components in the vehicle 102, for example, the processor 112, the memory device 114, the actuation system 116, the sensor system 118, the control system 120, and/or the infotainment system 122, can communicate over a communication interface 124, which may include a controller area network (CAN) bus. The communication interface 124 can provide an input and/or output communication mechanism within the vehicle 102. The communication interface 124 can also provide an application programming interface (API) to allow one or more components in the vehicle 102 to communicate with applications, running internal or external to the vehicle 102, in accordance with a particular communication protocol. The communication interface 124 can be implemented in hardware to send and receive signals in a variety of mediums, such as optical, copper, and wireless, and in a number of different protocols some of which may be non-transitory.

One or more vehicles 102A-102C can be configured to communicate with the cloud computing system 106 via the communication network 104. The communication network 104 can include the Internet, a cellular network (e.g., a GSM network, a UMTS network, a CDMA network, an LTE network, an LTE-Advanced network), a telephone network, a computer network, a packet switching network, a line switching network, a local area network (LAN), a wide area network (WAN), a global area network, a satellite radio channel, such as XM Sirius, a wireless LAN, Bluetooth, or any number of private networks currently referred to as an Intranet, and/or any other network or combination of networks that can accommodate data communication. Such networks may be implemented with any number of hardware and software components, transmission media and network protocols. Although FIG. 1 represents the network 104 as a single network, the network 104 can include multiple interconnected networks, such as the networks listed above.

The processor 112 can be configured to process instructions and run software, which may be stored in the memory device 114. The processor 112 can also use the communication interface 124 to communicate with other systems in the vehicle, such as the memory 114, the actuation system 116, the sensor system 118, the control system 120, and the infotainment system 122 in the vehicle 102a. The processor 112 can include any applicable processors, such as a system-on-a-chip that combines a CPU, an application processor, and/or flash memory.

The memory device 114 can include a non-transitory computer readable medium, including static random access memory (SRAM), dynamic random access memory (DRAM), flash memory, a magnetic disk drive, an optical drive, a programmable read-only memory (PROM), a read-only memory (ROM), or any other memory devices or combination of memory devices.

In some embodiments, at least a portion of one or more systems 116, 118, 120, 122 can be implemented in hardware using an application specific integrated circuit (ASIC). The at least a portion of one or more systems 116, 118, 120, 122 can be a part of a system on chip (SOC). In other embodiments, the at least a portion of one or more systems 116, 118, 120, 122 can be implemented in hardware using a logic circuit, a programmable logic array (PLA), a digital signal processor (DSP), a field programmable gate array (FPGA), or any other integrated circuit. In some cases, the at least a portion of one or more systems 116, 118, 120, 122 can be packaged in the same package as other integrated circuits.

In some embodiments, at least a portion of one or more systems 116, 118, 120, 122 can be implemented in software instructions stored in memory, for example, the memory device 114. The software instructions can be processed by the processor 112 to cause the vehicle 102 or its systems 116, 118, 120, 122 to operate in accordance with the software instructions.

The vehicle 102 can be configured to communicate with the cloud computing (CC) system 106 in a variety of configurations. For example, the vehicle 102 can be continuously coupled to the CC system 106 during the operation of the vehicle 102 via a cellular network. As another example, the vehicle 102 can be sparsely coupled to the CC system 106. For instance, the vehicle 102 can communicate with the CC system 106 when the vehicle 102 is at a dealer-shop for a regular check-up or at a gas station with a wireless local area network (WLAN) access.

In some embodiments, the amount of data transferred between the vehicle 102 and the CC system 106 can depend on the bandwidth of the communication network 104 via which the data is communicated. For example, when the vehicle 102 communicates with the CC system 106 via a cellular network, the vehicle 102 can limit the amount of data transmission to, or reception from, the CC system 106 (e.g., since data transmission costs can be expensive across a cellular network). As another example, when the vehicle 102 communicates with the CC system 106 via a WLAN at home, the vehicle 102 can increase the amount of data transmission to, or reception from, the CC system 106. As another example, when the vehicle 102 communicates with the CC system 106 using a dedicated wire interface at the dealer-shop, the vehicle 102 can maximize the amount of data transmission to, or reception from, the CC system 106.

In some embodiments, the frequency at which the data is communicated between the vehicle 102 and the CC system 106 can depend on the type of data. For example, when the vehicle 102 transmits the Global Positioning System (GPS) data to the CC system 106, the vehicle 102 can transmit the GPS data in substantially real-time (for example, every second). As another example, when the vehicle 102 transmits tire pressure data to the CC system 106, which may vary slowly over time, the vehicle 102 can intermittently transmit the tire pressure data at a longer time intervals (e.g., low frequency).

The network storage 110 in the CC system 106 can include a non-transitory computer readable medium, including static random access memory (SRAM), dynamic random access memory (DRAM), flash memory, a magnetic disk drive, an optical drive, a programmable read-only memory (PROM), a read-only memory (ROM), or any other memory or combination of memories.

### Enhanced Communication System

In some embodiments, a vehicle 102 can use power lines to provide communication between two or more components in the vehicle 102. A typical communication interface 124 includes (1) a power supply line, (2) a ground line, and (3) one or more signal lines. Because the communication interface 124 is typically connected to all necessary components to place them in communication, the communication interface 124 can include long, heavy wires. For example, the CAN bus in a vehicle can include about 2,200 meters of wire with separate wire pairs coupled to each sensor and actuator in the vehicle 102. Such a large amount of wiring can lead to complex wiring systems prone to design and implementation errors, and can add significant weight to the vehicle, leading to fuel inefficiencies. Furthermore, due to the complexity and a variety of engineering issues, it often takes a long time to manufacture the communication interface 124. Therefore, there is a strong need to develop a technology for reducing the complexity of the communication interface 124, thereby reducing the wiring harness length.

To address these issues, in some embodiments, the communication interface 124 can be configured to provide communication over power lines (for example, the power supply line and/or the ground line), thereby allowing the vehicle manufacturers to remove the one or more signal lines from the communication interface 124. Thus, in such embodiments, the communication interface 124 would include only the power supply line and the ground line.

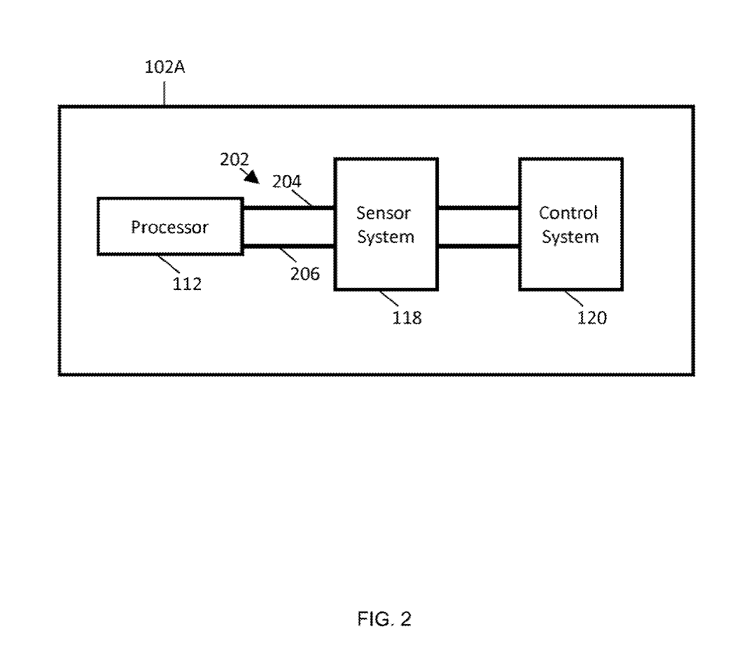

FIG. 2 illustrates a power-line communication system in accordance with some embodiments. The power-line communication system includes components of a vehicle 102, for example, a processor 112, a sensor system 118, and a control system 120. The power line communication system also includes a power line communication interface 202, which includes one or both of the power supply line 204 and the ground line 206.

The power lines in the power line communication interface 202 are configured to carry data in addition to the power supply signals (e.g., direct current signals) to provide communication between and/or among the vehicle components. For example, the power lines 204, 206 are configured to carry both the direct current signals for supplying power and a modulated carrier signal that embodies the data. The modulation mechanism and/or the modulation frequency for the data transmission can depend on components coupled to the power lines in order to reduce interference. Because the power line communication interface 202 can eliminate the need for signal lines that are typically present to facilitate vehicle communication, the power line communication interface 202 can allow vehicle manufacturers to reduce the length and/or weight of wires in the vehicle. In some cases, the power line communication interface 202 can couple the components in series (e.g., in a daisy-chain configuration), thereby further reducing the length and/or weight of the wire harness. The power line communication interface 202 can allow vehicle manufacturers to reach the market quickly by not having to worry about the wire harness design complexity.

In some embodiments, the power line communication interface 202 can be configured to use a packet switched protocol (e.g., with hubs and spokes placed in particular locations for efficiency). In some embodiments, the power line communication interface 202 can use existing power line communication protocols. For example, the power line communication interface 202 can be configured to use one or more of the following standards: HomePlug AV, IEEE 1901, Recommendation G.hn/G.9960, or Avionics Full-Duplex Switched Ethernet (AFDX) protocol.

The performance of the power line communication interface 202 can depend on impedance characteristics of the power line communication interface 202. In some embodiments, to improve the communication performance, the power line communication system can maintain an impedance model for the power line communication interface 202. In some embodiments, the power line communication interface 202 can include a calibration module that is configured to determine characteristics of the power line communication interface 202. For example, the calibration module can be configured to determine or “map” the impedance characteristics of the power line communication interface 202 so that the power line interface 202 can be adaptively configured to improve the communication performance. This way, vehicle manufacturers can dispense with expensive calibration steps to model the particular power line communication interface 202 in a particular vehicle 102 to improve the communication performance. In some embodiments, the calibration module can be distributed across the power line communication interface 202 to better characterize the power line communication interface 202 locally.

In some embodiments, the disclosed intelligent vehicular system can include an eavesdropper module that is configured to snoop or tap information from a communication interface 124 in the vehicle 102. In some cases, it is desirable to snoop or tap information from the communication interface 124 because it is difficult for a central processing system to aggregate information from all systems and devices by independently communicating with individual systems and devices. The eavesdropper module can operate on a processor and can include a transmitter and a receiver connection for the communication interface 124. The eavesdropper module can also be configured to communicate with the CC system 106 so that the eavesdropped information can be provided to the CC system 106. In some embodiments, the eavesdropper module can be configured to communicate with the CC system 106 using the communication network 104.

### Enhanced Sensor System

In some embodiments, the disclosed intelligent vehicular system can provide a virtual sensor that can be synthesized or simulated using easily observable features of a vehicle. In particular, the virtual sensor is configured to combine sensor signals to provide new information not attainable from individual sensors. The virtual sensor can be particularly useful in estimating a sensor signal that would be expensive to measure or impossible to measure. For example, it is generally desirable to measure the torque of an engine, a piston position of an engine, fuel-ethanol composition, a vehicle center of gravity, black ice on the road, or preferences for a person using the systems in a vehicle (e.g., a navigation system). However, such information is hard or impossible to measure with existing sensor technologies. To address this issue, the virtual sensor can synthesize the desired metric based on more easily observable measurements. The virtual sensor can combine signals from existing sensors. The existing sensors can include engine temperature sensors, vehicle acceleration sensors, and rotation-per-minute measurement of the engine. For example, the virtual sensor system can estimate the vehicle's center of gravity by fusing information from one or more of: (1) passenger occupancy sensors, (2) tire pressure gauges, (3) accelerometers, (4) gyroscopes, (5) steering wheel angles, etc.

In some embodiments, the virtual sensor can be trained using ground-truth data. In particular, if there exists an actual sensor that is capable of measuring the target signal simulated by the virtual sensor (e.g., the desired information), the actual sensor can be mounted on a test vehicle and can gather the ground-truth data for training the virtual sensor. In some embodiments, the virtual sensor can be trained by determining a mapping between the ground-truth data and the more easily obtainable sensor signals used to synthesize the virtual sensor. In some cases, the virtual sensor can be trained using a supervised learning technique, such as regression. In some embodiments, the accuracy of the virtual sensor can be tested using a few test vehicles or high-end vehicles that employ more sophisticated, expensive sensors. Once the virtual sensor is trained to estimate a signal that an actual sensor would measure, the vehicle manufacturer can remove the actual sensor from the vehicle 102 sold on the market and use, instead, the virtual sensor. This way, the vehicle manufacturer can reduce the cost associated with deploying the actual sensor.

In some embodiments, the virtual sensor can reside in the CC system 106. In such embodiments, the sensor system 118 can be configured to provide the measured sensor signals to the CC system 106, and the CC system 106 can, in response, estimate the target signal associated with the virtual sensor based on the measured sensor signals.

In some embodiments, the sensor system 118 can use the eavesdropper module in the communication interface 202, as discussed above, to collect sensor data from a variety of sensors on the vehicle 102. As discussed above, the eavesdropper module can be useful for providing sensor data to other parts of the intelligent vehicular system, such as the control system 120 and the CC system 106. When the communication interface 202 is encrypted, the eavesdropper module can decrypt the measured sensor signals prior to providing the snooped sensor data to other systems.

In some embodiments, the sensor system 118 can include a sensor fusion platform. The sensor fusion platform can be used to combine the sensor data from a variety of sensors in order to reduce the number of sensors deployed on a vehicle 102. Traditionally, because sensors are introduced to vehicles 102 without a global view of the vehicle 102, some sensors may be redundant. The sensor fusion platform can be used to, for example, (1) model existing sensors in a vehicle, (2) determine dependencies between or among the sensors, (3) determine an independent set of sensors from the dependencies, and/or (4) remove sensors that are not independent of other sensors. In some embodiments, the sensor fusion platform can use multivariate analysis techniques including a dimensionality reduction technique, such as a Principal Component Analysis, to identify the independent set of sensors from the dependencies.

In some embodiments, the safety of a vehicle 102 can be improved by embedding a smart sensor system into the vehicle 102 to identify and track potentially dangerous driving conditions. Vehicles can slip dangerously when they are operated on a surface with rapidly changing conditions (e.g., gravel, black ice). To address these rapid changes in surface conditions, the vehicle 102 can use the sensor system 118 to detect dangerous surface conditions and use the actuation system 116 to respond to the detected dangerous surface conditions. The sensor system 118 can include a smart sensor that is configured to report changes in surface conditions. The smart sensor can be coupled to the front of the vehicle 102. The smart sensor can be a LIDAR sensor or a vision sensor. In some embodiments, the smart sensor can be coupled to an inference engine to computationally detect potentially dangerous changes in surface conditions.

Traditionally, the sensor system 118 includes one or more sensors that are tested with a mechanical stimulus. For example, the sensor system 118 can include an inertial sensor, such as a low-Q gyroscope or a high-Q gyroscope, also referred to as a gyro sensor, whose bias stability (or sensitivity) is traditionally tested by physically shaking the sensor.

Testing the sensor system 118 with a mechanical stimulus can be expensive and the results may not be accurate. In particular, the accuracy of a mechanical test is inherently limited by the accuracy of the mechanical stimulus. Furthermore, a mechanical test can be prone to drifts (or time-dependent changes) due to time-dependent changes of mechanical stimuli and mechanical measurements. To achieve a high accuracy in such mechanical tests, sensors are often tested multiple times and the test results are averaged to yield the final test result. However, multiple iterations of testing can be time-consuming and expensive. Furthermore, when the sensor's temperature dependence is also measured, mechanical tests becomes even more expensive. In one example, the mechanical test is performed at a large number of temperature settings (e.g., 5 or more temperature settings) in order to fully characterize the temperature dependence. Such a large number of mechanical tests substantially increases the cost of sensors. Therefore, systems and methods for reducing the number of iterations of mechanical tests will result in significant cost and time savings.

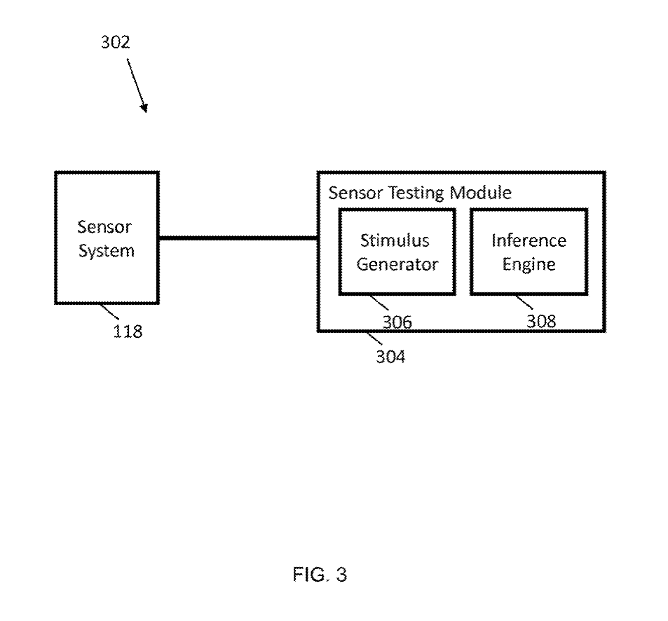

To address these issues, in some embodiments, a mechanical test of sensors can be complemented with an electrical test so that the number of mechanical test iterations can be reduced. FIG. 3 illustrates a sensor testing platform in accordance with some embodiments. The sensor testing platform 302 includes a sensor testing module 304 in communication with the sensor system 118, which includes one or more sensors to be tested. The sensor testing module 304 can further include a stimulus generator 306, which is configured to provide an electrical stimulus to the one or more sensors in the sensor system 118. The sensor testing module 304 can also include an inference engine 308 that is configured to receive responses, to the electrical stimulus, from the one or more sensors. Subsequently, the inference engine 308 can be configured to estimate, based on the responses to the electrical stimulus, one or more characteristics that would have been measured by the mechanical test. This way, certain mechanical tests can be replaced with electrical tests, which can be significantly easier to control and perform accurately. In some cases, the mechanical tests can be completely replaced by the electrical tests.

In some embodiments, the inference engine 308 can be trained using a supervised learning technique, such as regression. A variety of regression techniques can be used, for example, a linear regression technique or a non-linear regression technique, including a support vector regression technique. In some embodiments, the sensor testing module 304 can be integrated in the vehicle 102 itself, thereby allowing the vehicle 102 to periodically check the operation of the sensor system 118 already deployed in the vehicle 102.

In some embodiments, the sensor testing module 304 can be configured to determine temperature-dependent characteristics of one or more sensors based on tests at a limited number of temperature settings. For example, instead of testing the one or more sensors at five different temperature settings, the one or more sensors can be tested at only one or two temperature settings and still provide sufficiently accurate temperature-dependent characteristics of the one or more sensors.

To this end, the one or more sensors can be exposed to one or two temperature settings, and the stimulus generator 306 can provide either a mechanical stimulus or an electrical stimulus to the one or more sensors. Subsequently, the inference engine 308 can receive responses to the mechanical stimulus or the electrical stimulus. Then, the inference engine 308 can predict, based on the responses to the stimulus at the one or two temperature settings, the temperature-dependent characteristics of the one or more sensors at a larger number of temperature settings, for example five temperature settings. As discussed above, the inference engine 308 can be trained using supervised learning techniques, such as regression techniques.

In some embodiments, the sensor testing module 304 can use the inference engine 308 to reduce both the number of mechanical tests and the number of tests at different temperature settings, thereby further limiting the cost associated with testing sensors.

In some embodiments, the sensor testing module 304 can be integrated into the sensor system 118. In particular, the sensor testing module 304 can be integrated into the one or more sensors in the sensor system 118, thereby providing a built-in-self-test (BIST) for the one or more sensors. This would enable one to test the one or more sensors in the sensor In some embodiments, the inference engine 308 can include a Bayesian inference engine. The inference engine 308 can be implemented in software instructions stored in memory, for example, the memory device 114. The software instructions can be processed by the processor 112 to perform the inference operations, as discussed above. In other embodiments, the inference engine 308 can be implemented in hardware using an application specific integrated circuit (ASIC). The inference engine 308 can be a part of a system on chip (SOC). In other embodiments, the inference engine 308 can be implemented in hardware using a logic circuit, a programmable logic array (PLA), a digital signal processor (DSP), a field programmable gate array (FPGA), or any other integrated circuit. In some cases, the inference engine 308 can be packaged in the same package as other integrated circuits.

### Enhanced Analytics of Vehicles

In some embodiments, the disclosed intelligent vehicular system can enable smart vehicle analytics. For example, each vehicle 102 can be configured to gather and maintain the vehicle's health, driving pattern, or any information about the vehicle in the memory device 114 over a long period of time. Then the vehicle 102 can transmit signals representing the gathered information to the CC system 106 via the communication network 104. The CC system 106 can use the gathered information to analyze the vehicle's performance or health as a class (e.g., the performance of all vehicles from a particular brand or a particular model), or a particular vehicle's performance or health, or a particular driver's driving pattern. The summary of the analyzed data can be provided as a vehicle history report. The vehicle history report can include a series of sensor data measured over a period of time, for example, an acceleration of a vehicle, a tire pressure of a vehicle, any physical impacts on a vehicle, and/or engine failure events.

Such a vehicle history report can be useful in a variety of applications. For example, such analytics data can be useful for determining an insurance premium for a particular driver. Currently, insurance companies determine insurance premiums based on limited information about the vehicle or the driver. However, the insurance companies can use the vehicle history report to determine whether the driver is driving recklessly, whether the vehicle was in a near-accident, whether the vehicle is not maintained well to avoid mechanical failures, etc., and use that information to more adequately determine the insurance premium. As another example, such a vehicle history report can be useful for determining a warranty premium for vehicles that are out of warranty. An average vehicle is operative for about 12 years, but the warranty on the vehicle is often shorter than 12 years. Therefore, there is a market for providing extended vehicle warranties. When a vehicle is out of warranty, the driver can provide the vehicle history report to a dealer, and the dealer can determine a premium for the follow-up warranty based on the vehicle's health.

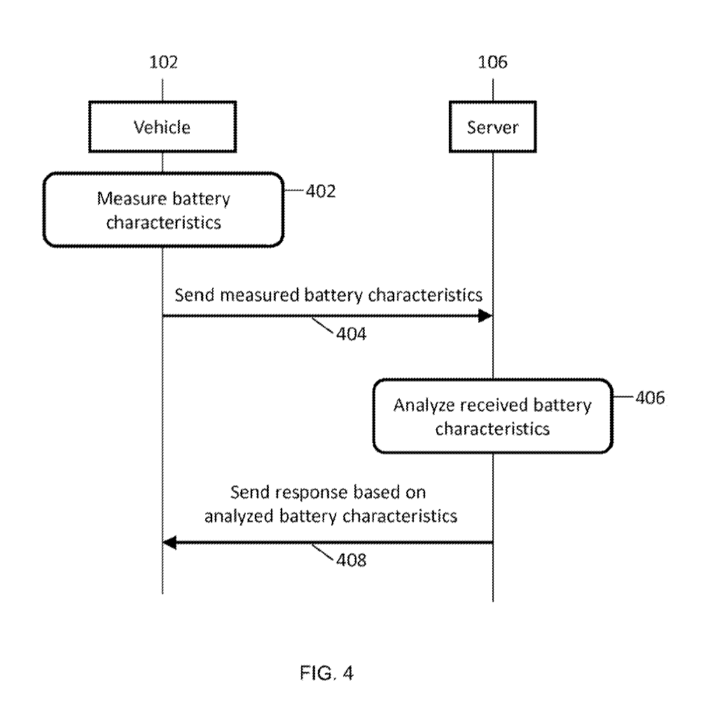

In some embodiments, the disclosed intelligent vehicular system can use the smart vehicle analytics to monitor the condition and/or operations of a vehicle's battery. FIG. 4 illustrates a method for monitoring a vehicle's battery in accordance with some embodiments. In step 402, the sensor system 118 is configured to measure characteristics of a vehicle's battery. For example, the sensor system 118 can include an analog-to-digital converter (ADC) coupled to one or more output terminals of the vehicle's battery, and the ADC can measure an output voltage or an output current of the battery and/or the amount of time and energy it takes to recharge the battery.

In some embodiments, the vehicle battery may comprise a plurality of stacked battery cells (e.g., stacked 4V battery cells). In such embodiments, the sensor system 118 can couple one or more ADCs to individual battery cells to monitor the characteristics of individual battery cells. The measured characteristics of individual battery cells can be fused to determine valuable information on. For example, the measured characteristics of individual battery cells can be used to identify potential battery failures, battery degradations, and/or battery improvements.

In step 404, the sensor system 118 can send the measured battery characteristics to a server 106. In some embodiments, the sensor system 118 can be configured to send the measured battery characteristics to the server 106 in real-time, for example, over a cellular communication network. In other embodiments, the sensor system 118 can be configured to send the measured battery characteristics to the server 106 when a high-band communication channel is available, for example, when the Wireless Local Area Network (WLAN) is available or when a wire communication channel is available for downloading the battery characteristics from the vehicle 102.

In step 406, the server 106 can process the measured battery characteristics to determine any useful information about the vehicle's battery. For example, the server 106 can analyze the measured battery characteristics to determine that the battery in the vehicle 102 is about to fail. If the server 106 determines that the driver should be warned about the battery characteristics, in step 408, the server 106 can send a response to the vehicle 102, including an appropriate warning. This allows manufacturers and vehicle dealers to provide predictive maintenance for vehicle batteries.

In some embodiments, the server 106 can also aggregate battery characteristics from multiple vehicles and determine characteristics of batteries in vehicles on the road. For example, the server 106 can analyze characteristics of a particular brand of batteries to determine the lifetime of batteries from the particular brand. As another example, the server 106 can analyze characteristics of batteries from a particular brand of vehicles to determine the vehicle's average battery performance. As another example, the server 106 can analyze characteristics of batteries from a particular geographic region to determine the dependence of the battery performance to certain geographical and/or environmental features, such as elevation, temperature, and humidity. As another example, the server 106 can analyze characteristics of batteries during a particular time of the year to determine the time-dependence of the battery performance.

In some embodiments, the control system 120 can include a centralized computation platform for a vehicle that is capable of fusing sensor data from the sensor system 118 and performing control actions based on the fused sensor data (e.g., model-based control). The system can cause the actuation system 116 to respond based on the fused sensor data. For example, the centralized computation platform can determine, based on the fused sensor data, to brake the vehicle, to steer the vehicle in one direction, to raise or lower the center of gravity of a vehicle using the suspension system in the actuation system 116, to provide a predetermine amount of tension on a seat-belt system, to perform predictive obstacle avoidance, to provide braking assistance, to provide stability control, to provide assistive steering during emergencies, and/or provide automated driving at lower speeds (e.g., less than 37 km/hour). To this end, the centralized computation platform can leverage probabilistic inference techniques. In particular, the centralized computation platform can be configured to use probabilistic inference techniques to determine appropriate control parameters for the actuation system 116. In some embodiments, the centralized computation platform can leverage data residing in the CC system 106 to enable new algorithms and/or firmware to more easily pass automotive qualification hurdles. In some cases, the centralized computation platform can also leverage the eavesdropper module to gain access to sensor data measured by the sensor system 118.

In some embodiments, the disclosed intelligent vehicular system can enable a vehicle 102 to monitor the quality of fuels and chemicals in the vehicle 102. Today, vehicle manufacturers and repair shops often measure the vehicle exhausts to estimate the fuel qualities in a crude manner. However, the exhaust measurement only provides a combustion quality of the fuels and fails to provide information on the chemical quality of the fuels. To extract both the combustion quality and the chemical quality of the fuels, the sensor system 118 can use a chemical sensor that is configured to monitor the quality of fuels and chemicals in the vehicle 102. This way, the sensor system 118 can determine, for instance, additives and impurities in the fuels (e.g., gasoline or diesel), the oil fluid quality, and/or the like. The determined quality of the fuels can be fused with the engine torque to better understand the combustion quality of the fuels. In some embodiments, the determined quality of the fuels can also be used to measure pressures in the engine cylinders in real time.

The chemical sensor in the sensor system 118 can use a variety of sensing modalities. In some cases, the chemical sensor can use an optical property of the fuel or the chemical to determine the quality of the fuel or the chemical. The optical property can include the optical index of the fuel or the chemical. For instance, when gasoline includes ethanol, the optical index of refraction would change because the index of refraction of ethanol is about 1.3, whereas the index of refraction of benzene is ˜1.5. In some cases, the chemical sensor can use impedance characteristics of the fuel or the chemical, such as capacitance, resistance, memristance, or piezo-electric properties, to measure the fluid characteristics. For example, the sensor system 118 can provide a signal having a particular frequency across the fuel and measure the capacitance and resistance change as a function of the input signal frequency. In some cases, the chemical sensor can use fluorescence of the fuel or the chemical, or MEMS sensors, such as MEMS cantilevers. In some cases, the chemical sensor can use spectroscopy.

The vehicle 102 can be configured to provide the measured fuel or chemical characteristics to the CC system 106. The CC system 106 can use the gathered information, along with geographic information retrieved from maps, such as Google Maps, to determine the gas quality of gas stations, or a vehicle's engine behavior based on the property of the fuel. Also, the CC system 106 can use the gathered information to determine the fuel quality of vehicles in a particular area of interest. The chemical characteristics can also be used locally at the vehicle 102 to improve the combustion characteristics of the engine, or to indicate when the vehicle 102 needs an oil change or should use a different fuel or additive.

In some embodiments, the vehicle operations can also adapt to the fuel quality in real time. For example, the vehicle 102 can configure parameters of the engine, tire pressures, or any mechanical/electronic parts to meet the target performance, such as Miles-Per-Gallon, the maximum engine torque, or the “smoothness” of the driving experience, based on the fuel quality.

In some embodiments, the disclosed intelligent vehicular system can be used to provide an effective vehicle maintenance mechanism. Oftentimes, existing vehicles do not readily indicate to drivers when a vehicle needs maintenance or when a subsystem of a vehicle is about to fail. Furthermore, the warning signs in vehicles are often not sufficient to indicate the need of maintenance because drivers are often unaware of what each warning sign means. This increases the risk of a vehicle's failure, and in turn, the risk of accident. Sometimes, vehicle owners or repair shops address this issue via preventive maintenance on subsystems that may or may not be in danger of failure, which increases the maintenance cost. Furthermore, vehicle owners or repair shops often do not have the information to make educated decisions on which parts to replace.

To address these issues, the disclosed intelligent vehicular system can be configured to provide analytics capabilities to indicate whether a subpart of a vehicle is about to fail. To this end, the sensor system 118 can be configured to measure and maintain signals about the vehicle 102 and provide the information to the CC system 106. The CC system 106 can analyze these signals to determine whether the signals have a pattern that indicates a failure of a subsystem in the near future. If the CC system 106 determines that some parts of the vehicle 102 may fail in the near future, the CC system 106 can send a warning signal to a user interface on the vehicle 102, such as a dashboard, or a driver's mobile device, such as a cell phone or a tablet computer, to indicate that the vehicle 102 needs maintenance. This system can be used in conjunction with the sensor fusion platform, described above, to improve the effectiveness of the near-future failure detection. This system can provide active marketing opportunities to manufacturers and vehicle dealers. In particular, this system can enable manufacturers and vehicle dealers to sell predictive maintenance, rather than preventive maintenance, to drivers by, for example, sending coupons for the predictive maintenance.

In some embodiments, the CC system 106 can learn patterns associated with a near-future failure of a vehicle using sensor data from the National Transportation Safety Administration. In other embodiments, the CC system 106 can gather, from real operating vehicles, sensor data on potential subsystem failures, degradations, and improvements. The CC system 106 can analyze the gathered sensor data to further determine correlations between subsystem failures.

In some embodiments, the vehicle maintenance mechanism can also be used to encourage a driver to buy a new vehicle based on the condition of the vehicle. For example, the system can provide such encouragement (e.g., as an advertisement, message, and/or the like) when the vehicle has many malfunctioning subsystems.

In some embodiments, the disclosed intelligent vehicular system can be used to provide a virtual black box for vehicle crashes. Today, vehicle crash data is gathered by vehicle manufacturers by actually crashing vehicles in a lab setting at a cost of over $100,000 per test. Such crash tests can be obviated when the crash data from real-life crashes can be aggregated. To this end, the sensor system 118 or the eavesdropper module can be configured to maintain information from all sensors in real-time. For example, the sensor system 118 can be configured to maintain real-time measurements from a variety of sensors, including gyroscopes, accelerators, cameras, RADAR sensors, sonar sensors, and/or LIDAR sensors as well as GPS system information. The system may also maintain data such as steering wheel angle, seat position, and mirror position. In some cases, the sensor system 118 or the eavesdropper module can maintain the sensor measurements in a circular buffer to avoid data over-flow problems, and can stop the recording of sensor measurements upon crash. The circular buffer can maintain the most recent sensor information (for example, the most recent 5 seconds, 10 second, 20 seconds or 30 seconds of data), and continuously overwrite older data. This way, the most recent real-time measurements, which presumably include the crash information, are guaranteed to be present in the circular buffer. Such a “virtual black box” for vehicle crashes can reduce the costs associated with vehicle crash tests. Furthermore, the virtual black box can identify sources of crashes, such as black ice, common accident areas (e.g., along sharp corners), and enable fixes to the vehicle or the environment to prevent future injuries.

In some implementations, the circular buffer stops recording and saves its data if an air bag deploys or rapid deceleration is detected. In one implementation, following air bag deployment or another metric indicating a car crash such as rate of deceleration, the data in the circular buffer is saved to a cloud via a communication network such as satellite, cellular, other wireless communication. In various examples, the circular buffer data may be wirelessly sent to or accessed by the car manufacturer or other workers responsible for road and car safety (such as police or other government employees). In some examples, the circular buffer data is stripped of information identifying the car owner or driver. In some instances, the circular buffer data includes the make and model of the car. Data aggregated from real accidents may be used to improve car safety.

In some embodiments, the sensor system 118 can be configured to determine whether a headlight of a vehicle 102 is dirty so that the headlight cleaner can be triggered only when the headlight is dirty. For safety reasons, it is important to keep the headlight of a vehicle 102 clean. In fact, some countries require vehicles to clean headlights to ensure that the headlights are sufficiently clean. Currently, vehicles are not equipped with any sensors that can determine whether a headlight of a vehicle 102 is dirty. Therefore, vehicles are often configured to clean the headlights periodically, for example, every 10 times the vehicle's engine is started. Such a periodic cleaning can unnecessarily consume a large amount of cleaning fluid because the vehicle 102 may clean its headlight even if the headlight is not dirty. Such an unnecessary consumption of cleaning fluid is problematic because the vehicle 102 is required to carry a large amount of cleaning fluid. Such unnecessary cleaning fluid can reduce the fuel efficiency of the vehicle and increase the cost of ownership. The sensor system 118 can address this issue by triggering the headlight cleaner only when the headlight is dirty. This allows the headlight cleaner to carry only a small amount of fluid, which can improve the fuel efficiency of the vehicle.

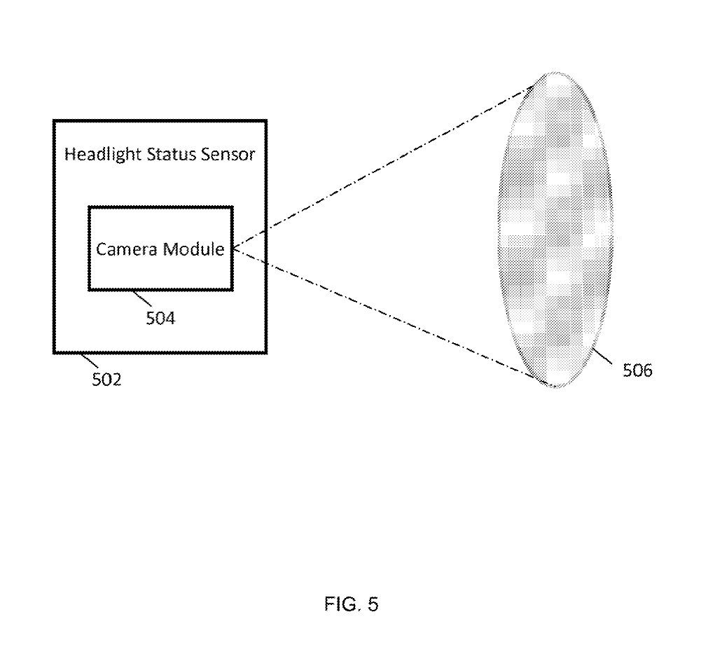

To this end, in some embodiments, the sensor system 118 can include a headlight status sensor configured to determine whether the headlight is dirty. FIG. 5 illustrates a headlight status sensor in accordance with some embodiments. The headlight status sensor 502 can include a camera module 504 that is capable of taking an image of the headlight 506. The headlight status sensor 502 can analyze the image of the headlight 506 to determine whether the headlight 506 is clean or dirty. In some cases, the camera module 504 can be sealed in a special heat-resistant container that can shield the camera module from the heat generated by the headlight.

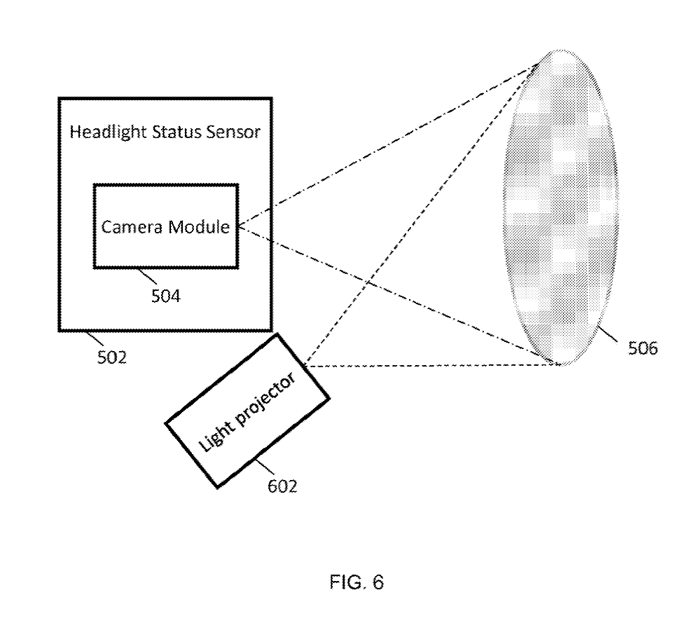

In some embodiments, the headlight status sensor 502 can operate in conjunction with a light projector. FIG. 6 illustrates a headlight status sensor in conjunction with a light projector in accordance with some embodiments. The light projector 602 can be configured to project light onto a surface of the headlight 506, and the camera module 504 in the headlight status sensor 502 can be configured to detect light reflected from the headlight 506. In some cases, the light projector 602 can be configured to provide patterned light to the headlight 506. For example, the light projector 602 can provide light in accordance with a compressed sensing technique. As another example, the light projector 602 can provide structured light that is configured to increase the resolution of an image captured by the camera module 504 focused on the headlight 506. To this end, the light projector 602 can include a filter that structures the light in accordance with the compressed sensing technique or the desired structure of light. Once the camera module 504 captures an image of the reflected light, the headlight status sensor 502 can analyze the reflected light pattern to determine whether the headlight is clean or dirty.

In some embodiments, the headlight status sensor can be triggered to determine the status of the headlight prior to the scheduled cleaning of the headlight. For example, when a headlight cleaner is configured to clean the headlight after 10 engine starts, the headlight status sensor can be triggered to determine the status of the headlight after 10 engine starts as well, but prior to the operation of the headlight cleaner. When the headlight status sensor determines that the headlight is clean, the headlight status sensor can cancel the scheduled operation of the headlight cleaner; when the headlight status sensor determines that the headlight is unclean, then the headlight status cancel can let the headlight cleaner to clean the headlight as scheduled.

In some embodiments, the headlight cleaner can be mounted on a movable system. The movable system can be maintained in a compartment, physically shielded from the light beam generated by the headlight. When the headlight cleaner is triggered to clean the headlight, the movable system is guided to the front of the headlight, and once the movable system reaches the front of the headlight, the headlight cleaner provides the headlight cleaning fluid to the headlight. In some embodiments, the headlight status sensor is mounted on the same movable system as the headlight cleaner. In such embodiments, as discussed above, the headlight status sensor is triggered to determine the status of the headlight (e.g., whether the headlight is clean or dirty) prior to the cleaning of the headlight.

In some embodiments, the sensor system 118 can be improved to provide additional range sensing capabilities at a lower power consumption. In particular, the sensor system 118 can be improved to provide additional spatial resolution in range sensor systems, such as a RAdio Detection And Ranging (RADAR) system, a LIght Detection And Ranging (LIDAR) system, and an ultrasound sensor system.

For example, the existing Complementary metal-oxide-semiconductor (CMOS) based RADAR sensor operates at 24 GHz. These sensors are often inexpensive, can see through hostile weather, and can sense vehicles in the close proximity, yet such sensors may not have sufficient resolution to sense smaller objects or targets located at a remote location, such as a pedestrian about 80 meters away (e.g., because it operates using only 200 MHz of bandwidth). The limited resolution of the RADAR sensor could be addressed using a RADAR sensor that operates at a different frequency, such as 77 GHz. Because such a sensor is capable of providing 1 GHz of bandwidth, it can provide better resolution compared to the RADAR sensor operating at 24 GHz. However, the 77 GHz RADAR sensor is typically extremely expensive (more than 8 times the cost of the CMOS counterpart) because it uses Silicon-Germanium (SiGe). Therefore, it is desirable to improve the resolution of the 24 GHz RADAR sensor without using an advanced, expensive process technology.

A LIDAR sensor system may also have similar issues. A LIDAR sensor system can detect range (or depth) information even in the dark. However, a LIDAR sensor system often has limited spatial resolution. Therefore, as with the RADAR system, a LIDAR sensor system cannot detect small objects or targets far from the LIDAR sensor. Existing ultrasound sensors also have limited spatial resolution. Ultrasound signals are impacted by environment, such as air turbulence of above 5 mph. Therefore, the range information attainable from the ultrasound signals can be limited in resolution and can be inaccurate.

These limitations of the range sensor systems (e.g., the limited resolution of the range sensor systems) can be addressed computationally. In particular, the sensor system 118 can improve the spatial and/or amplitude resolution of range information using a modulation mechanism in conjunction with Bayesian priors and coherence characteristics. For example, the sensor system 118 can be configured to provide or shine a patterned signal (e.g., a light signal, a radio frequency (RF) signal, an acoustic signal) to a target, and to detect reflections of the patterned signal (e.g., a light signal, a RF signal, an acoustic signal) from the target. By analyzing the reflections using Bayesian priors and coherence characteristics, the sensor system 118 can improve the spatial / amplitude resolution of the range information encoded in the reflections. In some embodiments, the sensor system 118 can use a time-division multiple access modulation, thereby performing a trade-off between the temporal resolution and the amplitude resolution. In some embodiments, the sensor system 118 can provide the desired modulation using a radio frequency array.

In some embodiments, the accuracy of the detected range information can be further improved using a priori information about the sensed environment. The a priori information can include knowledge about buildings, objects, landmarks, or any information about the surrounding of the vehicle that embodies the sensor system 118. Such a priori information can greatly aid the detection and recognition of target objects, such as pedestrians moving in front of a known façade of a building. This technique can be particularly useful for the RADAR sensor system in reducing the circular error probability (CEP), which is a measure of the smallest detectable object.

In some cases, the a priori information can be complex and data-intensive. Therefore, refining the detected range information at the sensor system 118 in the vehicle may be computationally too expensive. Therefore, in some embodiments, the vehicle 102 can provide the detected range information to the CC system 106 so that the CC system 106 can refine the detected range information on behalf of the vehicle 102. The vehicle 102 can also provide geographic information, such as a GPS coordinate, indicating the location at which the range information has been detected. In some cases, the vehicle 102 can be configured to provide the detected range information and/or the geographic information when a communication link (e.g., a wireless communication channel) to the CC system 106 is available. The vehicle 102 may be configured to compress the detected range information and/or the geographic information prior to transmission to the CC system 106.

Once the CC system 106 receives the detected range information and/or the geographic information, the CC system 106 can fuse the detected range information with the a priori information in the CC system 106, such as the vision and LIDAR information about the sensed surroundings. The fusion operation can include a subtraction operation to subtract the background of the scene from the detected range information. For example, the CC system 106 can compute a difference between the detected range information and the a priori range information at the geographic location of interest. The difference can indicate the locations at which the target objects are present.

In some embodiments, the a priori information can be retrieved from Google Street View and Maps. In some cases, the CC system 106 can speed-up the fusion of the detected range information with the a priori information by prefetching the a priori information ion. In some cases, the CC system 106 can prefetch the a priori information based on the traveling route of the vehicle 102. The traveling route of the vehicle 102 can be retrieved from the navigation system associated with the vehicle 102. In some embodiments, the CC system 106 can maintain a separate database of a priori information for a make and model of the vehicle since different vehicles may have different sensor system configurations.

### Enhanced Mapping

In one implementation, the data from the sensor system 118 is combined with map data to create an enhanced map. The enhanced map can be updated at regular intervals based on the sensor system 118 data. Data from any of the sensor systems described herein may be used for the enhanced map, including Radar, LIDAR, GPS, vision sensors, temperature sensors, inertial sensors, gyroscopes, accelerometers, radio frequency sensors, sonic sensors, odometers, speedometers, and steering wheel angle measurements. In one implementation, the enhanced map is stored remotely, and is updated based on sensor system data from multiple vehicles. The sensor system data may be used to determine road conditions including, for example, road work, closed roads, closed lanes, pot holes, ice, water, puddles, sand, gravel, and debris. The sensors may also use sensor data from multiple vehicles to update the map to indicate driving conditions such as decreased visibility due, for example, to fog, rain, snow, sleet, or sand. Map updates that indicate quickly changing conditions such as driving conditions are made frequently (e.g., every five minutes, every minute, every half minute, every few seconds or less than every few seconds). Map updates indicating road conditions which don't change as rapidly may be updated less frequently, or they may be updated simultaneous with driving condition updates.

The enhanced map can be stored on a remote server, and it may be stored in the cloud. Vehicles may send data to a server for use in updating the enhanced map. The vehicles can send the data using any available network, such as a cellular network, a satellite network, the car's radio unit, and LTE. In one example, the vehicle has a Bluetooth connection with a user's cellphone, and data is sent from the vehicle to the cellphone and from the cellphone to the cloud. In some implementations, the car sensor data is fused locally at the car before it is sent up to the cloud, decreasing the bandwidth of the data to be sent. In other implementations, the car sensor data is sent directly to the cloud, using greater bandwidth.

According to some implementations, sensor data from multiple vehicles can be used by safety officials to assess road safety. For example, the health of a bridge could be monitored using vehicle sensor data such as accelerometer measurements, gyroscope measurement, and inertial sensor measurements, and monitoring data on vehicle vibrations, and other vehicle movements, such as vertical vehicle movements.

In some implementations, the data from sensor system can be used for driver-assisted systems. In some implementations, the data from one or more sensor systems can be used for autonomous driving. In one example, data from sensor systems from multiple vehicles can be combined with map data to generate an autonomous driving route. According to one example, the data from other vehicles can be used to train the autonomous vehicle, such that the autonomous vehicle does not have to practice the route with a driver before autonomously driving.

### Enhanced User Experience

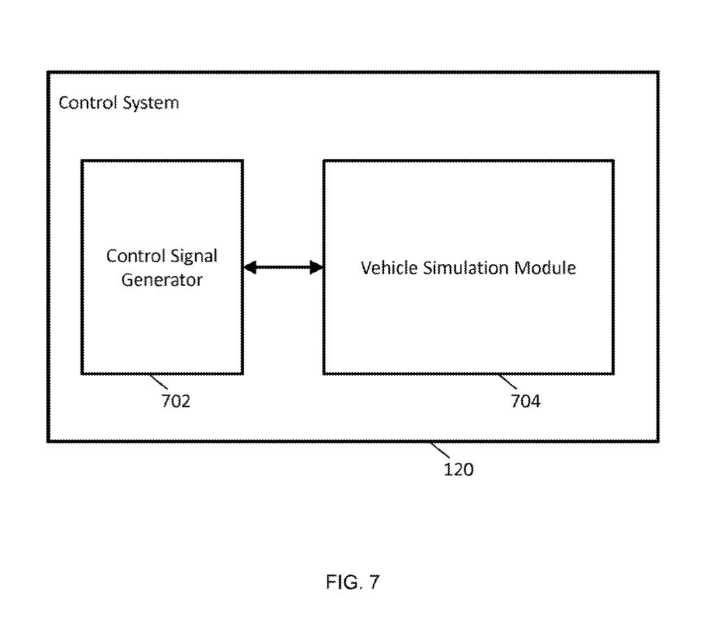

The disclosed intelligent vehicular system can be useful in providing an enhanced user experience to drivers and passengers. In some embodiments, the enhanced user experience can be provided by an intelligent control system 120. FIG. 7 illustrates an intelligent control system in accordance with some embodiments. The intelligent control system 120 can include a control signal generator 702 and a vehicle simulation module 704. The control signal generator 702 is configured to generate signals for controlling systems in the vehicle 102; the vehicle simulation module 704 includes a computational model of the vehicle 102 and is configured to provide information about the vehicle 102 to the control signal generator 702 so that the control signal generator 702 can adapt the control signals based on the information about the vehicle 102.

In some embodiments, the vehicle simulation module 704 can include a Computer Aided Design (CAD) model of the vehicle 102. The CAD model can be associated with a particular model of a vehicle or a particular vehicle, and can be obtained or learned from data associated with the particular model of a vehicle or the particular vehicle. For example, the CAD model of a vehicle can be learned using (1) a design of the vehicle, including the shape of the vehicle, the shape/size of the vehicle's cabin, the weight of the vehicle, the engine characteristics, the position of various sensors, the size/types of tires and the suspension system, and/or the position of passenger seats and (2) a test-drive data, illustrating the driving performance of a vehicle under various driving conditions as measured by a variety of sensors. Therefore, the CAD model can provide a computational estimate of a vehicle's current physical state based on which vehicle's characteristics (e.g., whether the vehicle is leaning to one side, how high the vehicle is from the road at certain points along the vehicle, etc.).

In some embodiments, the vehicle simulation module 704 can be configured to simulate an operation of a vehicle 102 under a particular control signal generated by the control signal generator 702. For example, when a control signal generator 702 is about to send an automatic brake signal to the brake system, the vehicle simulation module 704 can quickly simulate how that automatic brake signal would modify the vehicle's movement. Subsequently, the vehicle simulation module 704 can provide such simulation result to the control signal generator 702 so that the control signal generator 702 can adjust its control signals in accordance with the simulation result. For instance, if the automatic brake signal, configured to apply a brake for a long period of time, would likely cause a sliding of the vehicle, the control signal generator 702 can decide to issue an automatic brake signal configured to apply the brake multiple times in short pulses, thereby avoiding the sliding.

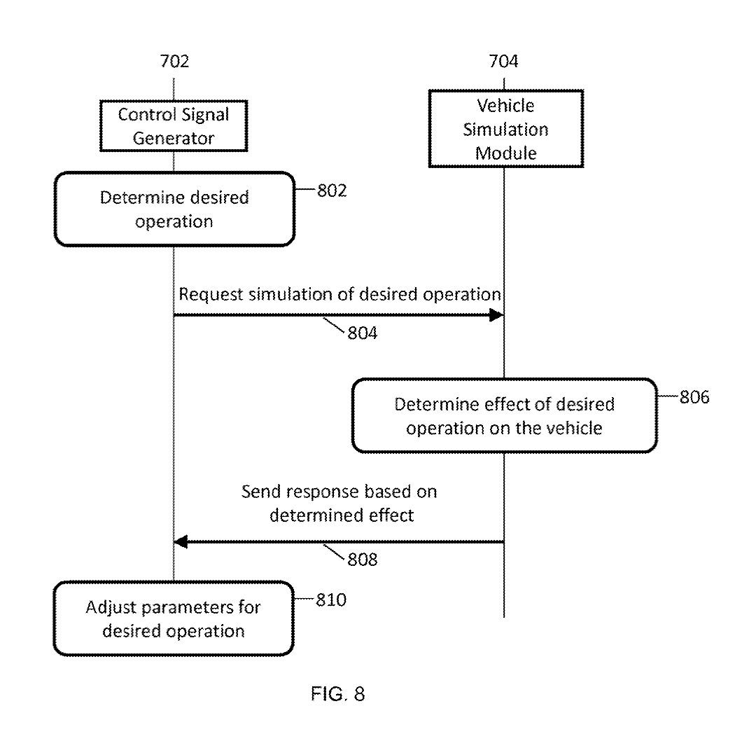

FIG. 8 illustrates a communication between a control signal generator and a vehicle simulation module in the control system in accordance with some embodiments. In step 802, the control signal generator 702 can determine a desired operation on a vehicle, such as applying a brake. In step 804, the control signal generator 702 can request the vehicle simulation module 704 to simulate an effect of the desired operation on the vehicle. In step 806, the vehicle simulation module 704 is configured to simulate the desired operation based on the computational model of the vehicle and/or real-time sensor signals received from the sensor system 118. In step 808, the vehicle simulation module 704 is configured to send a response to the control signal generator 702, based on its simulation results. In step 810, the control signal generator 702 is configured to adjust control signal parameters for the desired operation based on the simulation result from the vehicle simulation module 704.

In some embodiments, the vehicle simulation module 704 can be configured to determine a vehicle's center-of-gravity in real time, for example, using a virtual sensor as disclosed above, and use the center-of-gravity information to simulate a vehicle's response to control signals. For example, when a control signal generator 702 requests a simulation of a vehicle's movement in response to a brake signal, the vehicle simulation module 704 can use the center-of-gravity of the vehicle to simulate the vehicle's movement. This way, the control system 120 can control a passenger's driving experience in response to a control signal issued by the control system 120.

The vehicle simulation module 704 can be implemented in hardware to quickly provide simulation results to the control signal generator 702. In some embodiments, the vehicle simulation module 704 can be implemented using an application specific integrated circuit (ASIC). The vehicle simulation module 704 can be a part of a system on chip (SOC). In other embodiments, the vehicle simulation module 704 can be implemented in hardware using a logic circuit, a programmable logic array (PLA), a digital signal processor (DSP), a field programmable gate array (FPGA), or any other integrated circuit. In some cases, the vehicle simulation module 704 can be packaged in the same package as other integrated circuits. In some embodiments, the vehicle simulation module 704 can be implemented in software instructions stored in memory, for example, the memory device 114.

In some embodiments, the disclosed intelligent vehicular system can be used to improve the vehicle navigation system to reduce traffic congestion. For example, the vehicle 102 can be configured to transmit (1) its location information (e.g., the GPS coordinate) and (2) the destination of the trip to the CC system 106. The CC system 106 can subsequently aggregate the information received from all vehicles 102 to determine which vehicles should take a first route and which vehicles should take a second route. Based on the determination, the CC system 106 can update the recommended route for each vehicle in the area such that the traffic congestion is reduced. In some embodiments, the vehicle 102 can also send its speed information to the CC system 106, and the CC system 106 can further adjust the recommended route based on the moving speed of vehicles in the vicinity, which can be indicative of the traffic condition in the vicinity.

In some embodiments, the disclosed intelligent vehicular system can be used to improve the acoustic experience in vehicles. For example, the sensor system 118 can include a plurality of cameras facing towards the vehicle's cabin. The cameras in the sensor system 118 can take real-time videos of the cabin, and provide the video stream to the control system 120. The control system 120 can use that video stream to determine, alone or with help from the CC system 106, the location(s) of the passengers' ears. Then the control system 120 can actuate speakers in the actuation system 116 to improve the acoustic experience in the cabin. In some cases, the control system 120 can actuate a limited number of speakers (e.g., two speakers) to mimic a stereo system of 80 speakers. To enable the adaptive acoustic experience, the control system 120 can learn the cabin's acoustic characteristics from computer aided design (CAD) drawings and/or by modeling acoustic characteristics of a real vehicle cabin. In some embodiments, the control system 120 can use the vehicle simulation module 704 to learn the cabin's acoustic characteristics.

As another example, the disclosed intelligent vehicular system can improve the voice control capability in vehicles. The sensor system 118 can receive acoustic signals from the cabin, which may include (1) the voice command to which the control system 120 should respond and (2) noise, such as other passengers' voices, engine noise, and surrounding noise. The control system 120 can be configured to separate, alone or with help from the CC system 106, the voice command from the deluge of noise and respond to the voice command in a more effective manner.

As another example, the disclosed intelligent vehicular system can improve the acoustics within the cabin of the vehicle. For example, the actuation system 116 can be configured to provide sound to a certain portion of the cabin while cancelling out the sound in other portions of the cabin, thereby providing “a cone of silence” within the cabin. This allows a vehicle to accommodate multiple conversational zones. For example, the front seats can be one conversational zone; the back seats can be another conversational zone.

In some embodiments, the disclosed intelligent vehicular system can be used to provide an effective mechanism for reducing acoustic noise, such as the noise from an engine. An engine in a vehicle can be loud. Traditionally, the engine noise can be reduced (or muffled) using a physical sound insulation system located between the engine and the passenger cabin. Unfortunately, the physical sound insulation system can be heavy and expensive.

To reduce the engine noise at a lower cost and weight, the disclosed intelligent vehicular system can use an active noise cancellation system. The active noise cancellation system can include a microphone and a speaker. The active noise cancellation system can use the microphone to perceive or listen to the engine noise in the cabin and use the speaker to generate an acoustic signal that would counter-effect the engine noise in the cabin. In particular, the generated acoustic signal can be designed to have a destructive interference with the engine noise in the cabin.

In some cases, the active noise cancellation system can be configured to generate the acoustic signal from the perceived engine noise using a regression system. The regression system can be trained so that it is tailored to the statistics of the engine noise in the cabin.

In some embodiments, the active noise cancellation system can use a dedicated microphone and one or more dedicated speakers to perceive the engine noise and to actively cancel the perceived engine noise. In other embodiments, the active noise cancellation system can share the microphone and the speakers with other acoustic systems in the vehicles.

In some embodiments, the disclosed intelligent vehicular system can be configured to reduce wind-buffeting effects. For example, the vehicle 102 can be configured to use the active noise cancellation system to cancel out the wind buffeting effects. In particular, the active noise cancellation system can disrupt the resonances. To disrupt the resonances, the active noise cancellation system can change the airflow in the vehicle cabin and/or control the pneumatic pressure in the vehicle cabin. For example, the active noise cancellation system can be configured to roll down windows at predetermined speed settings; the active noise cancellation system can be configured to open or close the air ventilations in the cabin in a predetermined pattern.

In some implementations, the car's head unit can be updated using an external module such as a laptop, PDA, tablet, or phone. In one example, the head unit is updated using the Bluetooth interface between the external module and the car. The external module may download data from the cloud to update the head unit or microphone functionality. For example, the module can download updated source separation algorithms to improve microphone performance and noise cancelation. In other examples, the signals received at the car microphones may be sent to the cloud for source separation.

In some implementations, the CC system 106 interacts with the head unit in the car to update the head unit. For example, the cc system 106 can be used to add improved source separation functionality to the head unit.

In some implementations, the intelligent vehicular system can be used for user-selection of standard car audio sounds such as the indicator (or blinker) sound, and car warning sounds (e.g., seatbelt unbuckled or car door open warnings). Furthermore, in cars with minimal engine noise, such as electric cars, for which synthetic engine noise is often added so that others can hear the car approaching, a user could select the synthetic engine noise. In various examples, the user may select a car engine noise comprising a tune or other conventional engine sound. In some examples, a vehicle user may select vehicle sounds just like a cell phone user selects ringtones.

In some embodiments, the disclosed intelligent vehicular system can be configured to control the heating, ventilation, and air conditioning (HVAC) system in order to effectively divert resources to vital systems. In particular, the disclosed intelligent vehicular system can be configured to turn off power to HVAC in emergency in order to boost power to vital systems. Also, the disclosed intelligent vehicular system can be configured to detect uneven heating within the vehicle cabin, and provide air-conditioning to individual “zones” within the cabin.

In some embodiments, the disclosed intelligent vehicular system can be used to improve communication between the vehicle 102, drivers, and passengers. For example, the sensor system 118 can include a brain-computer interface that is capable of detecting alpha/beta waves from the brain. For instance, P300 brain waves can indicate how “hard” the driver is thinking Therefore, when the sensor system 118 provides the brain wave signals to the control system 120, the control system 120 can use the actuation system 116 to respond to the received signals. For example, the control system 120 can cause the actuation system 116, such as an audio system or a vibrating vehicle seat, to awaken a tired driver or a sleeping passenger. As another example, the control system 120 can cause the actuation system 116 to reduce distractions, such as the volume of the radio, when the driver is thinking hard. As another example, when the driver is thinking too hard, the control system 120 can alert the driver to focus on driving.

In some embodiments, the sensor system 118 can be configured to determine whether a driver is drowsy or not. For example, the sensor system 118 can be configured to analyze steering wheel movements and, optionally, other sensor data to determine whether a driver is feeling drowsy. The other sensor data can include images of the driver or the driver's eyes, whether there is another passenger in the cabin, whether another passenger is speaking, whether the driver is speaking, whether the vehicle's audio is on, and whether the driver is on a phone.

In some embodiments, the sensor system 118 can include a natural language interface to improve speech recognition for voice control of intelligent features in the vehicles 102. A driver of a vehicle can use a natural language interface for controlling features in the vehicle. For example, a driver can use the natural language interface to start a phone conversation, to use a navigation feature, to control the air conditioning, to turn on the cruise control, or to open the trunk. However, the natural language interface often performs poorly in vehicles because of various types of noise received by the natural language interface, including the engine noise, the road noise, the radio noise, the blower noise, and other background noise. To address these issues, the vehicle 102 can use the BASS technology provided by Lyric Labs of Analog Devices, Inc. of Cambridge, MA to improve the voice processing.

In some embodiments, the natural language interface can operate in conjunction with the CC system 106 to improve the voice separation and voice recognition performance of the natural language interface. For easy voice recognition tasks, such as simple commands for operating components of a vehicle 102, the natural language interface can operate independently of the CC system 106 and perform computations locally at the vehicle 102. However, for complex voice recognition tasks, such as dictating an email or processing voice commands with nuanced meanings, the natural language interface can send the voice signal to the CC system 106 so that the CC system 106 can use powerful voice processing techniques to perform voice separation and voice recognition.

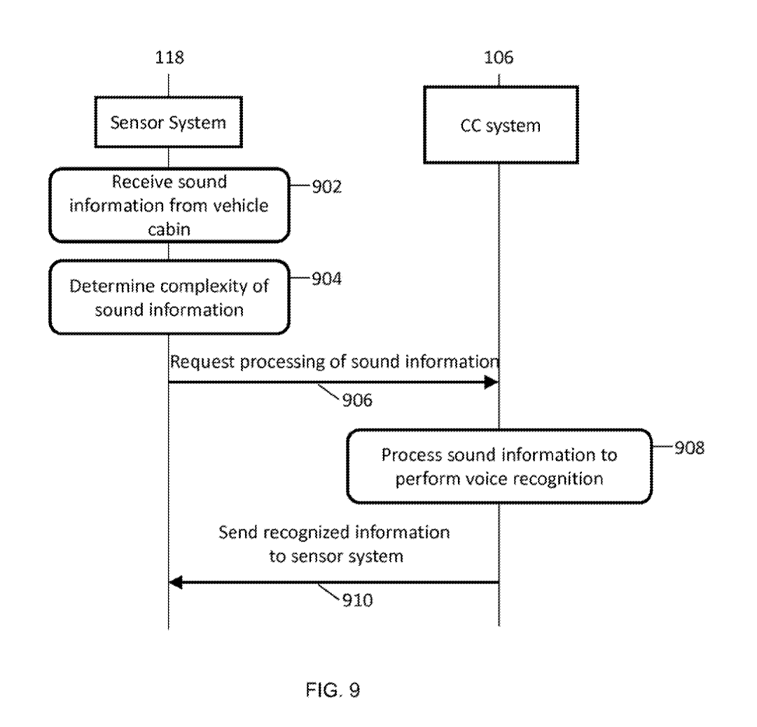

FIG. 9 illustrates a cloud-based voice processing flow in accordance with some embodiments. In step 902, the sensor system 118 can receive sound information from the vehicle cabin. In step 904, the sensor system 118 can determine the complexity of the sound information. For example, the sensor system 118 can determine whether the sound information corresponds to one of the voice commands maintained locally at the vehicle 102. If so, then the sensor system 118 can indicate that the sound information has a low complexity and that the sound information should be processed locally at the vehicle 102. If the sound information does not correspond to any of the voice commands maintained locally at the vehicle 102, then the sensor system 118 can indicate that the sound information has a high complexity. If the sound information is determined to have a high complexity, then in step 906, the sensor system 118 can send the sound information to the CC system 106, requesting the CC system 106 to process the sound information.

In step 908, the CC system 106 can use a blind source separation engine to separate voice information from the sound information, and process the separated voice information to perform voice recognition. The voice recognition may include recognizing a person associated with a voice signal, or recognizing a meaning of the words spoken in the voice information.

In step 910, the CC system 106 can optionally send the recognized voice information back to the sensor system 118 so that the sensor system 118 can use the recognized information for various applications, such as dictating emails or processing complex voice control commands for the vehicle 102.

In some embodiments, in step 906, if the communication network 104 is not available to provide communication between the sensor system 118 and the CC system 106, the sensor system 118 can locally process the sound information at the vehicle 102, even if the complexity of the sound information is high.

In some embodiments, a sensor system 118 can include a haptic natural language interface, also referred to as a “haptic interface,” a “haptic knob,” or an “Awesome knob.” An Awesome knob is a dynamic, haptic user interface based on a natural language interface. The Awesome knob combines voice control and a tactile interface (or a knob). For example, a user can speak commands to change the function of the tactile interface. Unlike existing natural language interfaces, in which the user has to indicate both (1) the variable the user wants to manipulate and (2) the amount of change to be applied to the variable, the Awesome knob system only requires a user to specify the variable the user wants to manipulate. Once the user provides a voice command, indicating the variable the user wants to manipulate, the actuation system 116 can associate a tangible user interface, such as a button or a knob, to the variable indicated by the voice command. Then the user can adjust that tangible user interface to manipulate the variable specified in the voice command. The Awesome knob system can enable vehicle designers to simplify and beautify the interiors of a vehicle. Furthermore, many in-dash control panels can be centralized to offer a significant cost advantage.

In some embodiments, the Awesome knob system can include (1) a voice recognition system, (2) electronics for receiving signals from the haptic interface, and (3) the haptic interface.

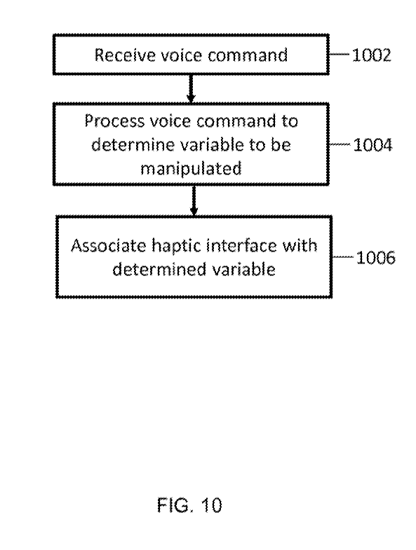

FIG. 10 illustrates a computerized method for the operation of an Awesome knob system in accordance with some embodiments. In step 1002, the Awesome knob system is configured to receive a user's voice command, indicating a variable that the user wants to manipulate. In step 1004, once the Awesome knob system receives the user's voice command, the Awesome knob system can process the voice command to determine the variable that the user wants to manipulate. In some embodiments, the Awesome knob system can maintain a limited set of commands associated with the Awesome knob in order to improve the accuracy of the voice command detection. In some embodiments, the Awesome knob system can use contextual information to determine appropriate commands for the Awesome knob. Oftentimes, certain commands are not contextually appropriate. For example, it is not appropriate to control the speed of a vehicle using the Awesome knob when the parking brake is latched. In other embodiments, the Awesome knob system can cooperate with the CC system 106 to process the received voice command for improved accuracy. In step 1006, the Awesome knob system can cause the actuation system 116 to associate a tangible, haptic user interface to the variable determined based on the voice command.

This Awesome knob system can provide a hybrid voice/haptic control. For example, the Awesome knob system can be configured to control the vehicle's temperature, fan speed, radio volume, radio tuning, and/or windows. An alternative (e.g., more traditional) mechanism to control these variables, that is not reliant on use of a voice command, may also be provided.

In some embodiments, the functionality of the Awesome knob can change based on whether it is the driver or the passenger that controls the haptic user interface. For example, the Awesome knob can prohibit or disallow the driver from controlling the navigation system when the vehicle is moving on the road, whereas the Awesome knob can allow the passenger to control the navigation system even when the vehicle is moving on the road. In one example, the Awesome knob can detect whether the driver or passenger is attempting the control based on a haptic interface that detects whether a left or right hand is touching the knob. In another example, the Awesome knob can detect which direction a voice command is coming from (the driver's side or the passenger's side) using acoustic source detection methods. The Awesome knob may be used to adjust the climate control system in the car, and, in one example, it may adjust the passenger-side climate system if the passenger is interacting with the knob, and adjust the driver-side climate system if the driver is interacting with the knob. In some cases, the haptic user interface can be configured to detect the amount of pressure applied to the haptic user interface. The amount of pressure can be used to further change the mode of the haptic user interface. In some embodiments, the haptic user interface is configured to detect various types of user interactions. For example, the haptic user interface can include the Touché interface disclosed in “TOUCHÉ: ENHANCING TOUCH INTERACTIONS ON HUMANS, SCREENS, LIQUIDS, AND EVERYDAY OBJECTS” in Proceedings of CHI, 2012.

In some embodiments, the Awesome knob system can be initiated when a user makes a physical interaction with the haptic interface. For example, the Awesome knob system can be initiated when a user places a hand on the haptic interface or when a user pushes a button on the haptic interface. In some cases, the user can first make a physical interaction with the haptic interface and then provide a voice command to change the functionality or application associated with the haptic interface. In other cases, the user can first provide a voice command and then make a physical interaction with the haptic interface. In this scenario, the Awesome knob system can be configured to constantly monitor (or maintain) voice information from the user, but process the voice information only when the user makes the physical interaction.

In some implementations, the Awesome knob may include one or more capacitive and/or optic sensors. The capacitive or optic sensors can be used to detect various grips, with different grips associated with different Awesome knob functions. For example, the Awesome knob may distinguish between a 2-fingered grip, a 3-fingered grip and a 4-fingered grip. In another example, the capacitive or optic sensors in the Awesome knob may distinguish between an overhand grip and a sideways grip based on finger or hand positioning on the knob.

In some implementations, the Awesome knob includes a gesture sensor, which can sense hand movements. In one example, the Awesome knob senses a hand movement and adjusts the balance and fade of the sound system to focus the sound where the hand is.

In some embodiments, the disclosed intelligent vehicular system can include an intelligent headlight system that is configured to shape light-fields of the headlight around obstacles. For example, the intelligent headlight system can be configured to track raindrops and shape light-fields of the headlight around raindrops. As another example, the intelligent headlight system can be configured to track pedestrians and/or other drivers and shape light-fields of the headlight around the tracked pedestrians and/or other drivers. This way, the headlight from the intelligent headlight system can avoid blinding pedestrians or other drivers.

In some embodiments, the disclosed intelligent vehicular system can be configured to warn drivers when an incompetent driver is on the road. For example, the sensor system 118 can monitor movements of vehicles surrounding the driver and provide the monitored information to the control system 120. The control system 120 can determine whether any of the surrounding vehicles is moving with characteristics that deviate from the normal movement characteristics. For example, the control system 120 can determine whether any of the surrounding vehicles is moving above a predetermined speed, or whether any of the surrounding vehicles is swerving dangerously. Once the control system 120 determines that one of the surrounding vehicles is moving with characteristics that deviate from the normal movement characteristics, the control system 120 can warn the driver to keep distance from the one of the surrounding vehicles. In some embodiments, the control system 120 can receive information on surrounding vehicles from an online database, for example, a driver license database or a CARFAX database that indicates the accident history of vehicles. The control system 120 can use the received information to determine whether the driver should keep distance from any of the surrounding vehicles.

In some embodiments, the disclosed intelligent vehicular system can be configured to adapt to a particular driver. For example, the sensor system 118 can measure driving characteristics of a driver, for example, steering wheel movements, a force with which an acceleration pedal is stepped on, a profile of a vehicle speed associated with a driver, a frequency at which a brake pedal is stepped on, a frequency at which a gear box changes the gear. Then the control system 120 or the CC system 106 can learn, based on the measured driving characteristics, the type of the driver. The control system 120 or the CC system 106 can use the determined driver type to adapt the driving experience of the vehicle to the driver.

In some embodiments, the disclosed intelligent vehicular system can be configured to warn a driver when the driver leaves a child or a pet in a vehicle. This feature can be particularly useful when the vehicle is exceedingly hot or exceedingly cold. The disclosed intelligent vehicular system can warn the driver using a phone call, a text message, a blog posting, or any other communication mechanism that can receive an immediate attention of the driver.

In some embodiments, the disclosed intelligent vehicular system can be configured to monitor gaze patterns of drivers to improve the design of sight lines.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the claims are presented in single dependency format in the style used before the USPTO, it should be understood that any claim can depend on and me combined with any preceding claim of the same type unless that is clearly technically infeasible.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A system for updated processing of audio signals in a vehicle, comprising:
a microphone for receiving the audio signals;
a transceiver for sending the received audio signals to a cloud computing system for processing, and for receiving the processed audio signals from the cloud computing system; and
a head unit for receiving the processed audio signals from the transceiver and playing the processed audio data through the vehicle's audio system.

2. The system of claim 1, wherein the processed audio signals have undergone source separation processing.

3. The system of claim 1, wherein the transceiver is a cell phone transceiver, and the cell phone is wirelessly connected to the vehicle.

4. The system of claim 3, wherein the cellphone is wirelessly connected to the vehicle using a Bluetooth connection.

5. A system for updating the function of a tactile interface in a vehicle, comprising:
a voice recognition system for identifying a voice command;
a tactile interface for receiving a tactile input;
a processor for connecting a user system in the vehicle with the tactile interface based on the identified voice command, and for processing the tactile input to update the connected user system.

6. The system of claim 5, wherein the tactile interface includes one of capacitve sensors and optic sensors for identifying a user grip.

7. The system of claim 6, wherein the user grip includes at least one of a left-handed grip, a right-handed grip, a two-fingered grip, a three-fingered grip, and a four-fingered grip.

8. The system of claim 5, wherein the tactile interface is one of a knob, a switch, and a button.

9. The system of claim 5, wherein the user system is one of sound system volume, sound system radio station, climate control system temperature, climate control system fan speed, heated seat control, cruise control, and windshield wiper speed.

10. The system of claim 5, wherein the voice recognition system identifies whether the voice command is from the driver's seat or the passenger's seat.

11. The system of 10, wherein processor connects a user system differently based on whether the command is from the driver's seat or the passenger's seat.

12. A method of enhancing map data, comprising:
accessing current map data;
collecting data from sensors in multiple vehicles, wherein the sensors include at least one of LIDAR sensors, radar sensors and inertial sensors;
determining road conditions based on the collected sensor data;
enhancing the current map data to include the road conditions.

13. The method of claim 12, wherein determining road conditions includes identifying changes in the road surface.

14. The method of claim 13, wherein changes in the road surface include at least one of potholes, ice, water, puddles, gravel, sand, and debris.

15. The method of claim 13, wherein determining road conditions includes identifying road closures, lane closures, and detours.

16. The method of claim 12, wherein collecting data from sensors in multiple vehicles includes receiving sensor data, wherein the sensor data is received from one of a vehicle radio unit and a phone connected to a vehicle head unit.

17. A system for improving vehicle safety by analyzing data from vehicle accidents, comprising:
a plurality of sensors installed in a vehicle for sensing vehicle information,
a circular buffer for recording the vehicle information, wherein the circular buffer is continuously refreshed, and wherein any vehicle information in the circular buffer at the time of a vehicle accident is saved;
a transmitter for transmitting data from the circular buffer to a cloud computing resource.

18. The system of claim 17, wherein the plurality of sensors include at least one of a LIDAR sensor, a radar sensor, an inertial sensor, an accelerometer, and a camera.

19. The system of claim 17, wherein identifying information is removed from the vehicle information, and wherein identifying information includes information that can be used to identify the vehicle involved in the accident.

20. A system for personalizing vehicle sounds, comprising:
a selection module including a plurality of personalized vehicle sounds for user selection, wherein vehicle sounds include engine sounds, indicator sounds, and warning sounds; and
a head unit for receiving the personalized vehicle sound selections from the selection module and playing the personalized vehicle sounds through a vehicle's audio system.
